(19) United States
(12) Patent Application Publication
(10) Pub. No.: US 2008/0083430 A1
(43) Pub. Date: Apr. 10, 2008

(54) ADJUSTABLE FLEXIBLE FLAP FOR MECHANIZED SWEEPER

(76) Inventor: Mark Schwarze, Huntsville, AL (US)

Correspondence Address: SIROTE & PERMUTT, P.C., P.O. BOX 55727, 2311 HIGHLAND AVENUE SOUTH, BIRMINGHAM, AL, 35255-5727, US

(21) Appl. No.: 11/539,363

(22) Filed: Oct. 6, 2006

(51) Int. Cl. B08B 13/00; B08B 7/00

(52) U.S. Cl. 134/6; 15/246

(57) ABSTRACT

A flap for a hood on a mechanized sweeper comprises a rubber member and connectors. The rubber member has a horizontal portion configured to overlay an upper surface of the hood and attach to the hood. The rubber member further has a vertical portion configured to extend perpendicularly downward from the upper surface of the hood. The connectors are configured to attach the horizontal portion of the rubber member to the hood such that the vertical portion of the rubber member extends downward to a depth equal to the depth of the hood.

### FIELD OF THE INVENTION

The present invention relates to mechanized sweepers. Particularly, sweepers used for sweeping paved areas, roads, paved motor vehicle parking lots, parking areas, parking structures and debris covered surfaces. More particularly, the invention relates to the flaps on the hood of the mechanized sweeper.

### BACKGROUND OF THE INVENTION

Various types of sweepers are used in sweeping paved surfaces. For example, truck mounted sweepers sweep highway and roadway surfaces. In general, pavement sweepers include a standard truck or specially designed chassis upon which the sweeper unit is mounted. Three basic categories of sweeper units are: re-circulating air sweeper, mechanical sweeper, and vacuum air sweepers. Generally, re-circulating air sweeper units include a motor driven fan, sweeping hood, a curved brush, and a debris separation hopper. The curb brush brings the debris into the path of the sweeping hood. The fan re-circulates airflow from the hopper through the sweeping hood and back into the hopper where dust, particles, and other debris are removed from the airflow by known separation techniques.

In re-circulating air sweepers, the sweeping hood is prone to maintenance from wear and damage. For example, the sweeping hood extends outside the wheel base and may hit objects that the truck otherwise avoids. Particularly, when the truck is cleaning parking lots and parking structures, it is also more likely the hood may hit curbs and support structures within the parking area. Exacerbating this problem, because debris may tend to clump in corners, drivers are forced to drive deep into the corners and near the curbs and support structures which further increases the likelihood of damage from hitting objects. In order to fix the damaged hood, the entire hood must be removed from under the sweeper in a labor and time intensive procedure.

In addition to damage, the hoods are subject to wear. The hoods include a series of rubber flaps that allow for debris to pass under the hood and be trapped until the re-circulating air may lift the debris into the hopper. The flaps extend to the ground so that the debris may be directed toward the hopper by the re-circulating air. As the sweeper moves through the parking lot, the flaps wear against the pavement. As the flaps wear against the ground, the flaps lose material. Once the material is lost from the flaps, then the hood is no longer able to contact the paved surface at the same hood height. If the flaps do not contact the surface, then the air that is re-circulated under the hood is no longer directed toward the hopper. Instead, the re-circulated air may flow out from underneath the hood and push debris out from the hood back onto the pavement.

In order to alleviate these problems, the driver generally employs one of two methods. The driver may lower the entire hood, or the driver may replace the rubber flaps. Replacing the rubber flaps requires removing the entire hood from under the sweeper and setting the flaps into the sweeper hood. By replacing the flaps, the hood height is maintained according to the original configuration. Alternatively, the driver may lower the hood so that the rubber flaps again contact the paved surface. Lowering the hood changes the dynamics of the hood. As the hood is lowered, the path of the re-circulating air changes in cross-sectional size. The decreased cross-sectional size requires higher air velocity to maintain the same flow rates. Higher flow rates changes the size of the debris that may be removed, such that larger debris will no longer be picked up by the re-circulating air flow. Therefore, the driver must decide between incomplete sweeping from a lowered hood or increased downtime from constantly replacing flaps.

### SUMMARY OF THE INVENTION

An aspect of the invention provides a flap for a hood on a mechanized sweeper. The flap comprises a rubber member and connectors. The rubber member has a horizontal portion configured to overlay an upper surface of the hood and attach to the hood. The rubber member further has a vertical portion configured to extend perpendicularly downward from the upper surface of the hood. The connectors are configured to attach the horizontal portion of the rubber member to the hood such that the vertical portion of the rubber member extends downward to a depth equal to the depth of the hood.

### BRIEF DESCRIPTION OF THE DRAWINGS

FIG. 1 is a diagram of a re-circulating air sweeper;

FIG. 2 is a view of the hood of the sweeper of FIG. 1;

FIG. 3 is another view of the hood of the sweeper of FIG. 1;

FIG. 4 is an expanded view of the hood of FIG. 1;

FIG. 5 is a view of a front flap of the hood of FIG. 1;

FIG. 6 is a view of a cartridge flap of the hood of FIG. 1; and

FIG. 7 is a view of the hood including connections to the sweeper.

### DESCRIPTION OF THE PREFERRED EMBODIMENTS

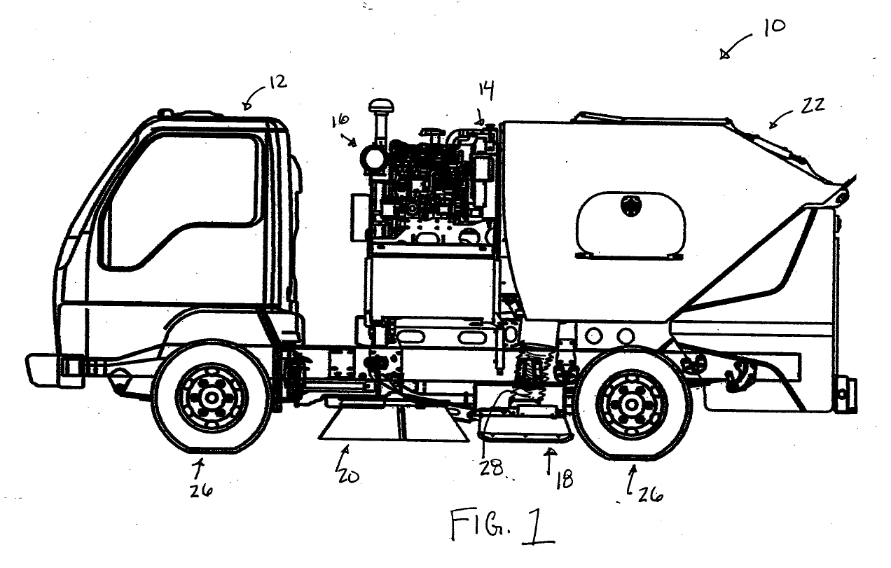

Turning now to the drawing figures, FIG. 1 is a diagram of a re-circulating air sweeper 10. The sweeper 10 includes a cab 12, a fan 14, a motor 16, a sweeping hood 18, a curb brush 20 and a hopper 22. The sweeper 10 is generally a specialized vehicle supported on four tires 26 and mounted on a standard utility truck chassis. As the sweeper 10 moves down a road, debris and trash under the hood 18 passed through a flexible hose 28 to the hopper 22 for collection. The brushes 20 in front of the hood 18 rotate and push debris into the path of the hood 18. The fan 14 blows air through one side of the hood 18. The air is then returned to the hopper 12 through the flexible connecting member 28. In this embodiment, the fan is located on the passengers side and the return is located on the driver's side of the vehicle 10. Having the return 28 on the driver's side allows for a driver to better align the portion of the hood 18 under the return 28 with trash and debris that is moving under the driver and along the curbs. However, reversing the position of the fan and the return such that the fan 14 is on the driver's side and the return 28 is on the passenger's side may also effectively remove debris and trash from the surface.

The fan 14 is powered by the motor 16. An intake 30 of the fan 14 pulls air from the hopper 22, pushes the air through a hood entry and passes the air through the hood 18 back through the return 28 into the hopper 22. Within the hopper 22, a filter filters the air prior to passing the air through the intake. In this manner, the air that enters the fan 14 is filtered from small debris which may have been picked up through the air if the intake was vented to atmosphere. The motor 16 is configured to power the re-circulating air sweeper system, but is not responsible for propulsion of the sweeper 10. However, fluid reservoirs meant to supply both the motor 16 and the engine of the sweeper 10 may be shared between these two components.

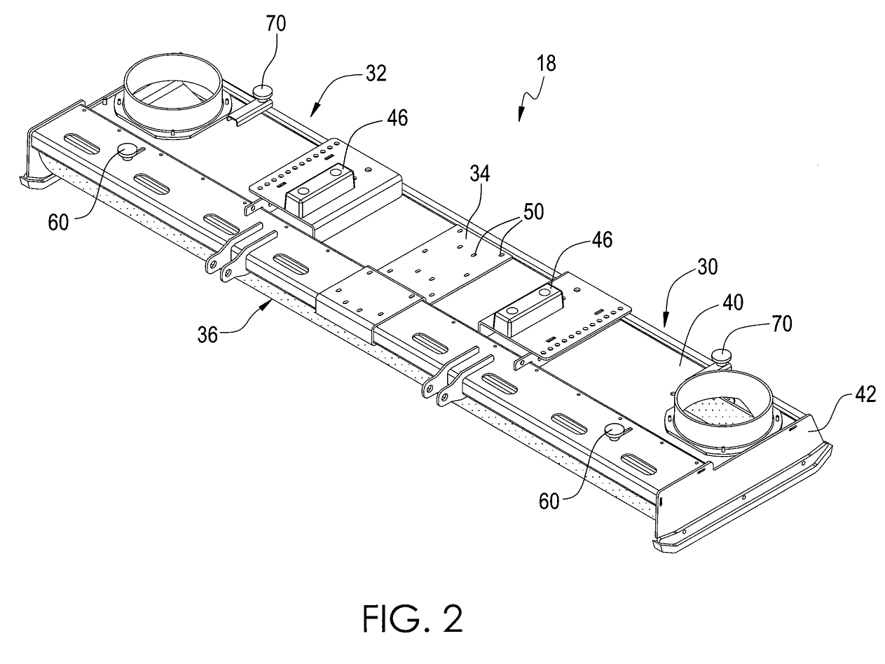

Turning now to FIG. 2, FIG. 2 is a view of the hood 18 of the sweeper 10 of FIG. 1. The hood 18 includes a left section 30, a right section 32, a central mating section 34, and a front flap 36. The left and right sections 30 and 32 are generally similar in shape and size. The left and right sections 30 and 32 are mirror images of one another along a central axis across the central mating section 34. The left and right sections 30 and 32 include a generally rectangular elongated top surface 40 and a skirt end 42. The skirt end 42 is generally perpendicular to the elongated top surface 40 extending downward from the top surface 40 and extending parallel to the short axis of the elongated top surface 40. The left and right sections 30 and 32 also include sweeper connections 46 for connecting the hood 18 to the sweeper. Opposite the skirt end 42, at the other end of the top surface 40 along the long axis of the top surface 40, mating structures 50 are configured to attach the sections 30 and 32 to the central mating section 34.

The central mating section 34 attaches the left and right sections 30 and 32 to each other through the central mating section 34. The central mating section 34 allows for each side section 30 and 32 to be removed individually from the hood 18. In a single piece hood, the entire hood would need to be removed to repair any damage to a section.

The central mating section 34 is configured to overlay portions of the side sections 30 and 32. The central mating section 34 and the side sections 30 and 32 are connected so that the hood 18 is structurally stiff. However, the connectors 50 between the central mating section 34 and the side sections 30 and 32 may be configured to shear so that forces exerted on the side sections 30 and 32 do not damage the side sections 30 and 32, instead damaging a simple connector. The sections, then, are relatively flexible to direct impacts while maintaining stiffness in normal operating conditions.

If a side section 30 or 32 is damaged, then repair may be achieved quicker and more cost effectively by having to only replace a single side portion 30 or 32. Access to a single side portion 30 or 32 is less labor intensive than fully removing the entire hood. In addition, replacing only a single side section 30 or 32 does not require removing additional connections between the hood 18 and the sweeper. Moreover, the lower costs associated with shipping smaller parts at less weight also reduce the total cost of maintenance.

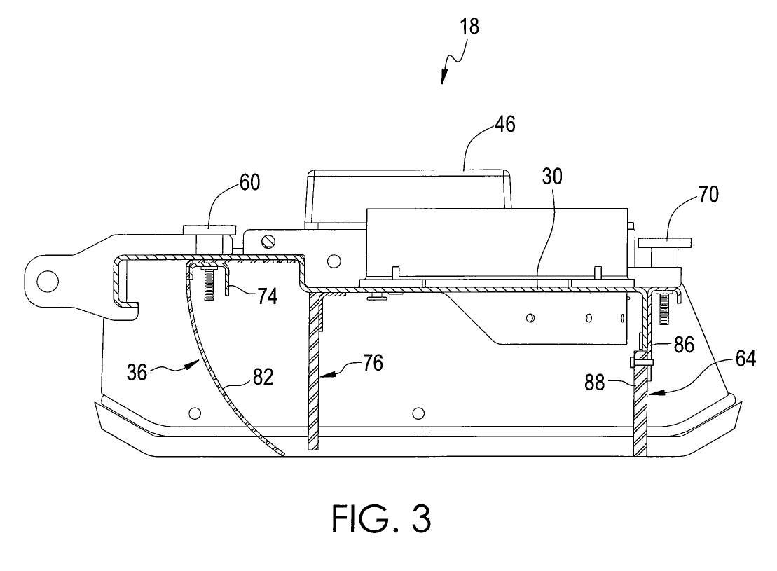

The front flap 36 of the hood 18 extends over the elongated top surface 40 of the left and right portions 30 and 32 and the central mating section 34 and extends perpendicularly downward as deep as the end skirt 42. An outer edge 50 of the front flap 36 abuts the end skirt 42. The end skirt 42 and the front flap 36 are the lower extension of the hood 18. Together with a back flap (discussed with reference to FIG. 3 below), the front flap 36 and the end skirts 42 form a plenum under the elongated top surface 40 of the side portions 30 and 32 and the central mating section 34. The plenum is the chamber under the hood 18 through which the air flows from the fan 14 through the flexible hose to the hopper.

The plenum is ideally a constant volume chamber. When the end skirts 42 abut the ground, the volume of the plenum is approximately the product of the length and width of the elongated top surfaces 40 and the depth of the end skirts 42. A constant volume chamber allows for a constant airflow through the plenum. As air enters the plenum from the fan 14, an equal amount of air exits the plenum through the flexible hose 28. At each cross section parallel to the end skirt 42 through the plenum, an equal amount of air travels. If the cross section parallel to the end skirt 42 is reduced in size, then in order to move the same amount of air that enters through the fan requires an increased velocity of the air as it flows through the plenum. Bernoulli's principle requires that as the air moves faster, the pressure drops. A drop in pressure limits the size and weight of the debris removed from the paved surface.

The front flap 36 and the end skirts 42 also must abut the paved surface so that air does not flow out from under the hood 18. The front flap 36 and the end skirts 42 direct flow of air from the fan to the flexible hose 28. If the front flap does not reach the pavement, then air may escape under the hood 18 over the paved surface. Escaping air may push debris away from the hood 18 and also limits the ability of the air to push the debris under the hood 18 through the flexible hose 28.

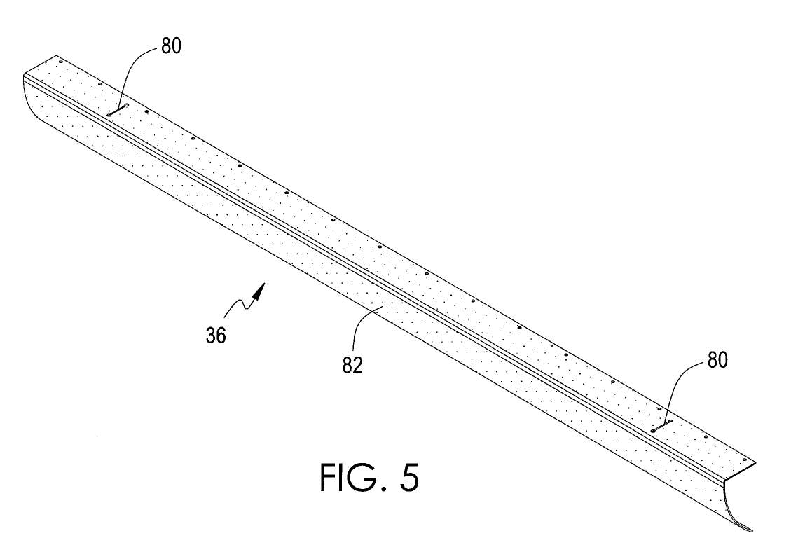

The front flap 36 is flexible such that debris that hits the front flap 36 lifts the flap 36 so that the debris may enter the plenum for collection. However, as the front flap 36 hits the pavement, wear removes parts of the front flap 36 so that the flap does not touch the pavement. The front flap 36 is configured so that the flap may be lowered relative to the hood 18. Slotted connectors 60 attach the front flap 36 to the hood 18. The slotted connectors 60 are received through a slot (as shown in FIG. 5) in the front flap 36 and are threaded into the hood 18. As the connector 60 is tightened, the front flap 36 is compressed and locked in place between the connector 60 and the hood 18. The compressed front flap 36 then does not move relative to the hood 18. When the connectors 60 are loosened, then the front flap 36 may be moved relative to the hood 18. As the front flap 36 is worn, the connectors 60 may be loosened and the front flap 36 may be extended so that the front flap 36 becomes flush with the pavement. Thus, instead of replacing the entire front flap 36, or being forced to lower the hood 18, the length of the front flap 36 may be adjusted to maintain the space under the hood 18 and maintain the contact with the pavement.

FIG. 3 is another view of the hood 18 of the sweeper 10 of FIG. 1. The view of FIG. 3 is a side view, with the end skirt removed. The hood 18 includes a rear cartridge flap 64. The hood has been described above. The rear cartridge flap 64 extends perpendicularly downward from the elongated upper surface 40. The cartridge flap 64 abuts the ground at the rear part of the hood 18. The cartridge flap 64 attaches to the hood 18 by rear connectors 70. The rear connectors 70 are threaded into the cartridge flap 64 and the hood 18. As the rear connectors 70 are progressed downward, the rear cartridge flap 64 is lowered toward the ground.

Similar to the front flap 36, the purpose of the rear cartridge flap 64 is to maintain the depth of the hood 18 and maintain contact between the hood 18 and the pavement. As the rear cartridge flap 64 is worn away from contact with the pavement, the rear connectors 70 may be advanced so that the bottom edge of the rear cartridge flap 64 may maintain contact with the pavement without having to drop the hood 18 downward.

The cartridge flap 64 includes a rigid member to attach to the rear connectors 70. The rigid member is formed from an upper U-shaped member 66 and a downward projecting straight support member 68. The upper U-shaped member 66 is inverted such that the horizontal part of the U-shaped member may receive the rear connectors 70. The U-shaped member 66 is rigidly attached to the straight member 68. The straight member 68 extends downward to shorten the distance to the flexible portion of the flap. In the rear of the hood, it may be beneficial to have a slightly stiffer flap than in the front of the hood. While debris is meant to push under the front flap, the debris is not meant to roll out from underneath the hood at the rear.

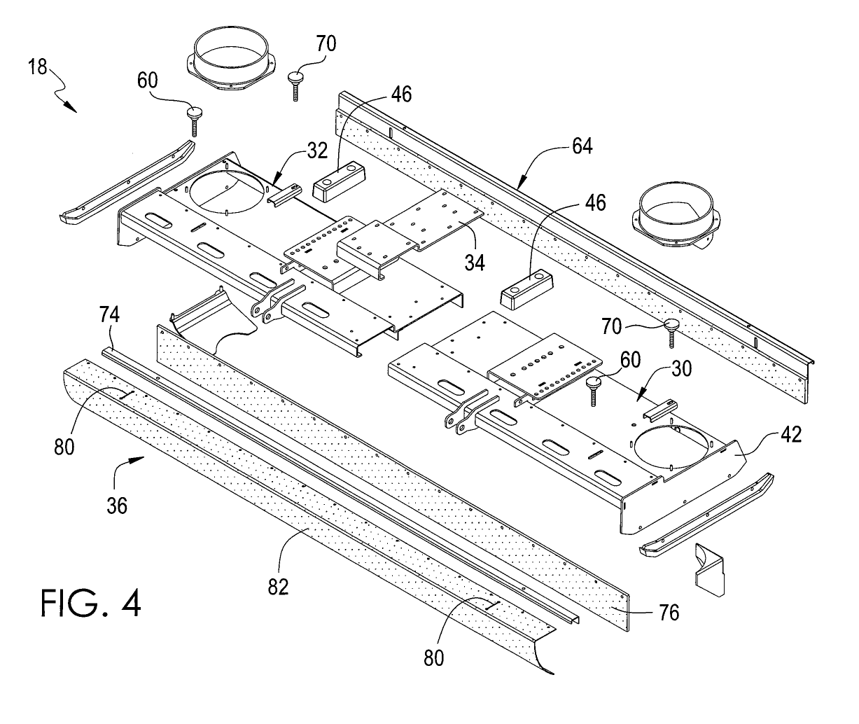

FIG. 4 is an expanded view of the hood of FIG. 1. The hood 18 includes the left section 30, the right section 32, the central mating section 34, the front flap 36, the rear cartridge flap 64, a support bar 74, and an interior flap 76. The support bar 74 extends along the long axis of the hood 18 between the end skirts 42. The bar receives the slotted connectors 60. The front flap 36, then, is compressed upon the support bar 74 so that the front flap 36 may be fixed, but include adjustability by relieving the pressure on the front flap 36 by reversing the slotted connectors 60.

The interior flap 76 is located behind the front flap 36. The interior flap 76 acts as a check valve for the plenum. As debris passes the front flap 36, the circulating air under the hood may not escape because the air flows between the interior flap 76 and the rear cartridge flap 64. As the debris passes the front flap 36, the interior flap 76 maintains contact with the pavement. Once the debris passes the front flap 36, then the front flap 36 falls back into contact with the pavement. As the debris passes the interior flap 76, the front flap 36 maintains contact with the pavement and the plenum under the hood 18.

FIG. 5 is a view of the front flap 36 of the hood 18 of FIG. 2. The front flap 36 includes slots 80. The slots 80 are configured to receive the slotted connectors of the hood. The slots 80 are configured so that the front flap 36 may be slidably advanced relative to the hood so that the front flap 36 may maintain contact with the paved surface. A lower edge 82 of the front flap 36 is the lowermost projection of the front flap 36. This edge 82 is worn on the pavement as the flap 36 contacts the pavement.

The slots 80 in the flap 36 also allows for more of the flap 36 to be used prior to removing the flap 36. The flap 36 may be lowered a distance equal to the length of the slot 80. Thus, the edge 82 of the flap 36 may be worn away for a distance equal to the length of the slot 80. This reduces the environmental impact of the wasted portion of the front flap 36.

Increasing the total length of the flap 36 may also increase the life of the front flap 36. As debris contacts the front flap, the additional rubber that is flexed over the upper surface of the hood may absorb some of the impact from the debris. Thus, more of the flap 36 may be used and the wear of the flap 36 may be reduced.

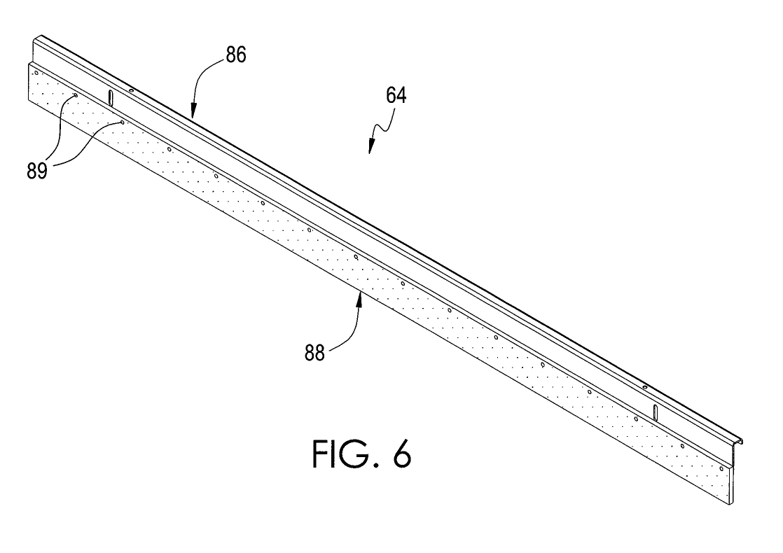

FIG. 6 is a view of the cartridge flap 64 of the hood 18 of FIG. 3. The cartridge flap 64 includes a cartridge 86 and a flexible rubber member 88. The cartridge 86 is configured to receive rear connectors 70 to set the depth of the rear cartridge flap 64 over the pavement. The cartridge 86 is also configured to receive the rubber member 88. The rubber member 88 is the flexible portion of the rear flap 64.

As the cartridge flap 64 is lowered, the rubber member 88 maintains contact with the pavement. The use of the cartridge 86 allows for minimal rubber use in the rubber member 88. Because the cartridge 86 (and thus the rubber member 88) may be lowered to the depth of the rear connectors 70, the waste rubber in the rubber member 88 is minimized.

The cartridge 86 is coupled to the rubber member 88 through a plurality of connectors 89 located along the length of the cartridge flap 86 and the rubber member 88. In another embodiment, the cartridge 86 may slidably receive the rubber member 88 laterally, for example through a dove tail joint between the cartridge 86 and the rubber member 88. The rubber member 88, then, would be supported in the hood by the cartridge 86 and held in place laterally by the end skirts of the hood. In another embodiment, the rubber member 88 may be attached to the cartridge 86 by a compression member exerting a force to squeeze the rubber member 88 to the cartridge 86. The compression member is configured to fixedly attach the rubber member 88 to the cartridge 86. Because the rear flap 64 may be more rigid than a front flap, the length of the cartridge may be elongated to increase stiffness. Increased stiffness may come at the expense of more frequent replacement, as the rubber member 88 is likely to wear faster and the amount the flap may be lowered is limited to the depth of the rubber member 88.

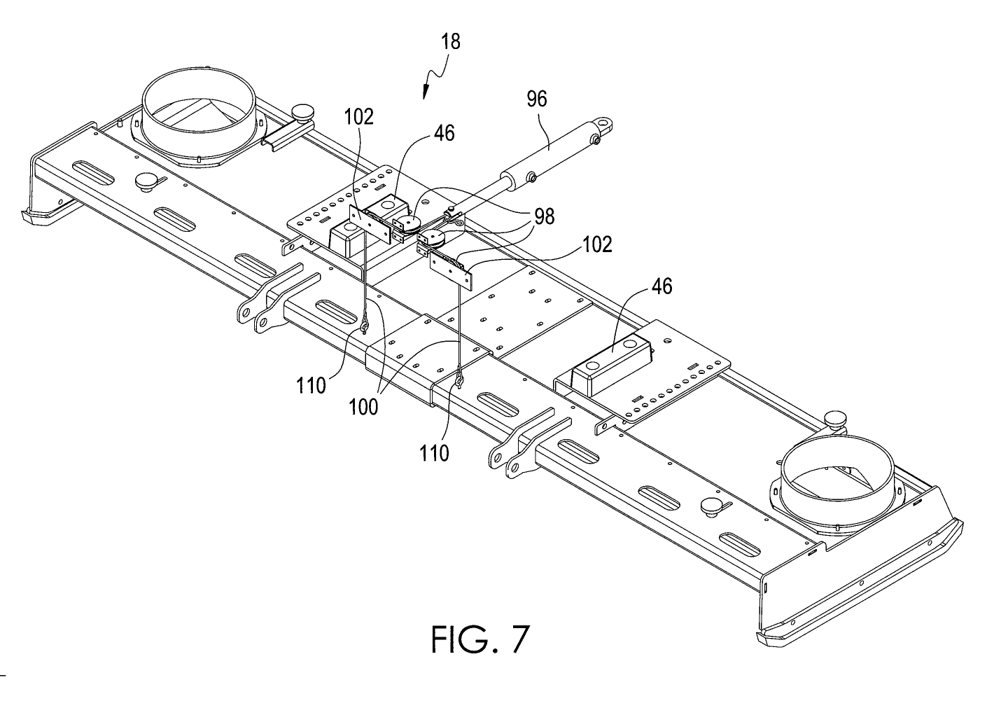

Turning now to FIG. 7, FIG. 7 is a view of the hood 18 including connections to the sweeper. The hood 18 is configured to attach to the sweeper. Hood connectors 46 include brackets configured to receive connecting members from the sweeper. The connecting members include connecting arms and a connecting piston 96. The connecting arms are connected to the hood connectors 46 at the hood 18. The connecting arms allow the hood 18 to rotate relative to the sweeper while still supporting the hood 18.

The connecting arms are also pinned to the sweeper. The connecting arms are shaped such that forces that lift and drop the hood 18 are appropriately transmitted through the connecting arms. The connecting arms are also formed to deform when forces are exerted on the hood 18 that attempt to rotate the hood 18 over the pavement. The is connecting arms, then, are the portion of the sweeper that is most deformable to impacts from debris to the hood 18. This allows a simple connecting arm, instead of the hood portions, to be replaced.

The hood 18 is also connected to the sweeper through a piston 96. The piston 96 attaches to two pulleys 98 through guide wires 100. Mounting brackets 102 attach the pulleys to the sweeper. The guide wires 100 are attached to the hood 18 through a pair of eye bolts 110. The piston 96 is configured to quickly lift the hood off the pavement. The controls for the piston 96 are located within the cab of the sweeper so that the operator may lift and lower the hood from within the cab while operating the sweeper. By popping the hood up, the operator may be able to clear larger, lighter debris that is unable to be swept under the front flap 36 of the hood 18. Lighter, larger debris may not be pushed under the hood 18 like most debris because the larger debris requires more force to be pushed under the hood 18. When the debris is not pushed under the hood, the debris may build up in front of the hood 18. A build up in front of the hood limits the effectiveness of the sweeper in sweeping debris.

When the operator engages the piston, the piston length shortens and the hood 18 is raised. The operator may keep the hood 18 raised as the operator drives over the debris so that the debris is swept under the hood 18. When the hood 18 is simply kicked up, then the debris is funneled between the interior flap and back flap of the hood 18 and may be removed from the paved surface into the hopper. This saves time and labor where an operator previously would be required to push debris from the front of the hood 18 after stopping the sweeper and laboring in front of the hood 18 to remove the debris.

While the piston 96 has been attached to the hood 18 through guide wires, it may be possible to directly couple the piston 96 to the hood 18. Moreover, it may be possible to provide the same effect through other means besides a piston. For example, a four bar linkage, a motor, or a screw drive may raise the hood 18 in order to clear debris from the front of the hood 18.

As will be apparent to one skilled in the art, various modifications can be made within the scope of the aforesaid description. Such modifications being within the ability of one skilled in the art form a part of the present invention and are embraced by the claims below.

1. A flap for a hood on a mechanized sweeper, comprising:
a. a rubber member having a horizontal portion configured to overlay an upper surface of the hood and attach to the hood and further having a vertical portion configured to extend perpendicularly downward from said upper surface of the hood; and
b. connectors configured to attach said horizontal portion of said rubber member to the hood such that said vertical portion of said rubber member extends downward to a depth equal to the depth of the hood.

2. The flap of claim 1, wherein said connectors are further configured to adjustably attach said rubber member to the hood.

3. The flap of claim 2, wherein said connectors are bolts rotatably received in the hood.

4. The flap of claim 3, wherein said bolts are configured to compress said upper portion of said rubber member between a portion of said bolts and the hood.

5. The flap of claim 4, further comprising an end skirt configured to extend perpendicularly from said upper surface of the hood and perpendicularly from said vertical portion of said rubber member, said end skirt configured to restrict lateral movement of said rubber member.

6. The flap of claim 1, wherein said horizontal portion of said rubber member is further configured to have a plurality of slots configured to receive said connectors.

7. The flap of claim 6, wherein said plurality of slots are further configured to extend horizontally across said horizontal portion of said rubber member.

8. The flap of claim 7, wherein said plurality of slots in said rubber member are further configured to adjustably lengthen said vertical portion of said rubber member by sliding forward said horizontal portion of said rubber member relative to said connectors such that part of said horizontal portion of said rubber member elongates said vertical portion of said rubber member.

9. The flap of claim 1, wherein said connectors are bolts rotatably received in the hood, said horizontal portion of said rubber member further configured to have a plurality of slots configured to receive said bolts such that said horizontal portion of said rubber member is compressed between said bolts and the hood.

10. The flap of claim 9, wherein said plurality of slots in said rubber member are further configured to adjustably lengthen said vertical portion of said rubber member by sliding forward said horizontal portion of said rubber member relative to said connectors such that part of said horizontal portion of said rubber member elongates said vertical portion of said rubber member.

11. A method of lowering a flap on a hood of a sweeper, comprising the steps of:
a. threading a plurality of adjustable connectors through a rubber member;
b. adjusting the depth of said rubber member by advancing said rubber member along an upper portion of the hood such that a portion of said rubber member extends downward to a depth equal to the depth of the hood; and
c. compressing said rubber member to the hood with said plurality of adjustable connectors such that said rubber member is fixedly held in place relative to the hood.

12. The method of claim 11, further comprising the step of threading said plurality of adjustable connectors into a compression member on the hood.

13. The method of claim 12, wherein said adjusting step comprises the steps of:
a. providing a plurality of slots in said rubber member;
b. receiving said plurality of adjustable connectors in said slots; and
c. sliding said rubber member relative to said plurality of adjustable connectors such that said plurality of adjustable connectors are advanced in said slots.

14. The method of claim 13, further comprising the step of forming a plurality of receiving holes in a compression member configured to receive said plurality of adjustable connectors.

15. The method of claim 14, wherein said forming step further comprises the step of threading said plurality of receiving holes such that said adjustable connectors are advanced on the threads in said plurality of receiving holes.

16. A rubber flap for a hood on a sweeper, comprising:
a. a horizontal portion configured to overlay an upper surface of the hood;
b. a vertical portion configured to extend perpendicularly downward from said upper surface of the hood; and
c. a plurality of adjustable connectors configured to attach said horizontal portion to the hood such that said plurality of adjustable connectors are configured to lower said vertical portion to a depth equal to the depth of the hood.

17. The flap of claim 16, wherein said horizontal portion is further configured with a plurality of slots configured to receive said plurality of adjustable connectors.

18. The flap of claim 17, wherein said plurality of slots are further configured to extend horizontally across said horizontal portion.

19. The flap of claim 18, wherein said plurality of slots in said horizontal portion are further configured to adjustably lengthen said vertical portion by sliding forward said horizontal portion relative to said plurality of adjustable connectors such that part of said horizontal portion elongates said vertical portion.

20. The flap of claim 16, wherein said plurality of adjustable connectors are bolts rotatably received in the hood, said horizontal portion of said rubber member further configured to have a plurality of slots configured to receive said bolts such that said horizontal portion is compressed between said bolts and the hood.

21. A device for lowering a flap on a hood of a sweeper, comprising:
a. means for threading a plurality of adjustable connectors through a rubber member;
b. means for adjusting the depth of said rubber member by advancing said rubber member along an upper portion of the hood such that a portion of said rubber member extends downward to a depth equal to the depth of the hood; and
c. means for compressing said rubber member to the hood with said plurality of adjustable connectors such that said rubber member is fixedly held in place relative to the hood.

22. The device of claim 21, further comprising means for threading said plurality of adjustable connectors into a compression member on the hood.

23. The device of claim 22, wherein said adjusting means comprises:
a. means for providing a plurality of slots in said rubber member;
b. means for receiving said plurality of adjustable connectors in said slots; and
c. means for sliding said rubber member relative to said plurality of adjustable connectors such that said plurality of adjustable connectors are advanced in said slots.

24. The device of claim 23, further comprising means for forming a plurality of receiving holes in a compression member, said receiving holes configured to receive said plurality of adjustable connectors.

25. The device of claim 24, wherein said forming means further comprises means for threading said plurality of receiving holes such that said adjustable connectors are advanced on the threads in said plurality of receiving holes.
